(19) United States
(12) Patent Application Publication
(10) Pub. No.: US 2020/0135046 A1
(43) Pub. Date: Apr. 30, 2020

(54) ELECTRONIC APPARATUS, STORAGE MEDIUM, CONTROL DEVICE, AND CONTROL METHOD

(71) Applicant: SHARP KABUSHIKI KAISHA, Sakai City, Osaka (JP)

(72) Inventors: MEGUMI YOKOGAWA, Sakai City, Osaka (JP); KIYOFUMI OHTSUKA, Sakai City, Osaka (JP); TADAO ANDOH, Sakai City, Osaka (JP)

(21) Appl. No.: 16/606,460

(22) PCT Filed: Apr. 6, 2018
(86) PCT No.: PCT/JP2018/014793

§ 371 Date: Oct. 18, 2019

(30) Foreign Application Priority Data
May 31, 2017 (JP) 2017-108760
Aug. 10, 2017 (JP) 2017-155906

(51) Int. Cl. G09B 19/00; H04W 4/021

(52) U.S. Cl. CPC G09B 19/00; H04W 4/021

(57) ABSTRACT

An object is to enhance a user's motivation for cheering for a sport and motivate the user to cheer at a stadium or the like. An electronic apparatus (10) includes: at least one motion detecting device (13); and at least one control device (11), the at least one control device (11) being configured to, in a case where at least one motion is detected by the at least one motion detecting device (13), carry out a point acquiring process that includes acquiring a point(s) corresponding to the at least one motion, the at least one motion each being a motion of a body of a user.

### TECHNICAL FIELD

The present invention relates to an electronic apparatus, a program, a control device, and a control method.

### BACKGROUND ART

Conventionally, research and development have been carried out on an electronic apparatus that infers the emotion of a user from the user's facial expressions or the like and then outputs an image, a voice message, or the like appropriately responding to the inferred emotion. For example, Patent Literature 1 discloses an electronic apparatus that includes: a user state analyzing section that analyzes a state of a user; a content information analyzing section that analyzes a state of content; a comment generating section that prepares, based on the user state and content state thus analyzed, a comment that is presumed to gain empathy from a user; and a comment outputting section that outputs the prepared comment in the form of sound or the like.

### CITATION LIST

### Patent Literature

### Patent Literature 1

Japanese Patent Application Publication, Tokukai, No. 2016-186741 (Publication date: Oct. 27, 2016)

### SUMMARY OF INVENTION

### Technical Problem

However, the state of a user (which is to be analyzed by the user state analyzing section) detected by the electronic apparatus disclosed in Patent Literature 1 is the user's facial expression, voice, pulse rate, or the like, instead of a motion of the user's body. Therefore, when, for example, the user is watching a sport at a stadium, the electronic apparatus is not able to make an appropriate response according to, for example, the number and degree of the user's cheering gestures. As such, the electronic apparatus is not capable of enhancing the user's motivation for cheering or motivating the user to cheer at the stadium or the like.

An aspect of the present invention was made in view of the above issue, and an object thereof is to provide an electronic apparatus which makes a response in a way that enhances motivation for cheering for a sport and that makes a user want to cheer at a stadium or the like.

### Solution to Problem

In order to attain the above object, an electronic apparatus in accordance with an aspect of the present invention is an electronic apparatus including: at least one motion detecting device; and at least one control device, the at least one control device being configured to, in a case where at least one motion is detected by the at least one motion detecting device, carry out a point acquiring process that includes acquiring a point(s) corresponding to the at least one motion, the at least one motion each being a motion of a body of a user.

In order to attain the above object, a control device in accordance with another aspect of the present invention is a control device for controlling an electronic apparatus, the control device including a point acquiring section that is configured to, in a case where at least one motion is detected by a motion detecting device, acquire a point(s) corresponding to the at least one motion, the at least one motion each being a motion of a body of a user.

In order to attain the above object, a control method in accordance with a further aspect of the present invention is a method of controlling an electronic apparatus, the method including: a motion detecting step including detecting at least one motion, the at least one motion each being a motion of a body of a user; and a point acquiring step including, in a case where the at least one motion is detected in the motion detecting step, acquiring a point(s) corresponding to the at least one motion.

### Advantageous Effects of Invention

An aspect of the present invention makes it possible to provide an electronic apparatus which makes a response in a way that enhances motivation for cheering for a sport and that makes a user want to cheer at a stadium or the like.

### BRIEF DESCRIPTION OF DRAWINGS

FIG. 1 is a block diagram illustrating a functional structure of each of wearable terminals in accordance with Embodiments 1 and 2 of the present invention.

FIG. 2 is a block diagram schematically illustrating each of sport cheering systems in accordance with Embodiments 1 and 2 of the present invention.

FIG. 3 illustrates an appearance of each of the wearable terminals in accordance with Embodiments 1 and 2 of the present invention.

FIG. 4 is a flowchart showing an example of a method of controlling a wearable terminal in accordance with Embodiment 1 of the present invention.

FIG. 5 is a flowchart showing an example of a method of controlling a wearable terminal in accordance with Embodiment 2 of the present invention.

### DESCRIPTION OF EMBODIMENTS

### Embodiment 1

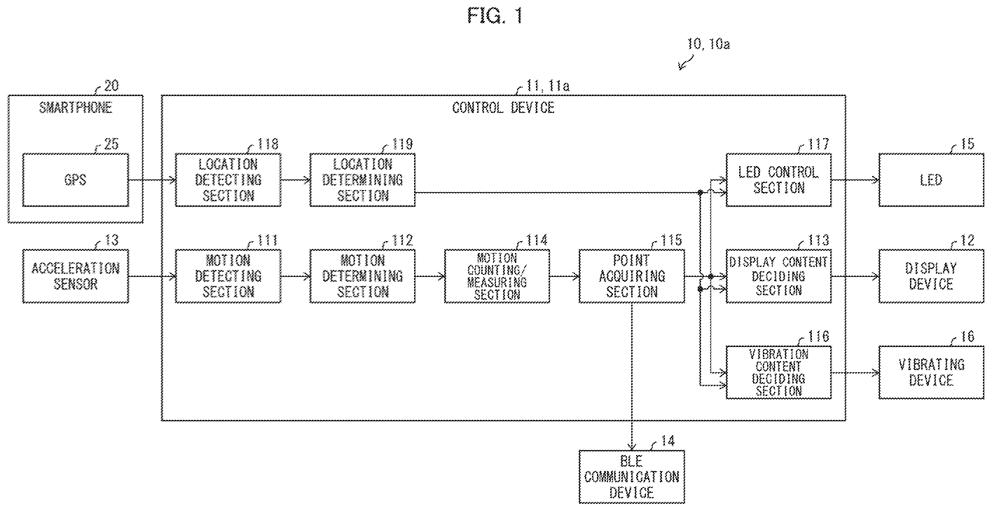

The following description will discuss an embodiment of the present invention in detail with reference to FIGS. 1 to 4. For convenience of description, members having functions identical to those described in a certain section are assigned identical referential numerals, and their descriptions are omitted.

Note that the descriptions of Embodiment 1 and subsequent embodiments are based on examples in which an electronic apparatus in accordance with an aspect of the present invention is a wristwatch type wearable terminal. Examples of the electronic apparatus in accordance with an aspect of the present invention include not only such wristwatch type wearable terminals but also wristband type wearable terminals, glasses type wearable terminals, body-wearing type wearable terminals, and earphones.

In Embodiment 1 and subsequent embodiments, the number of devices of each kind included in an electronic apparatus in accordance with an aspect of the present invention, such as the number of control devices or the number of information presenting devices, may be one or two or more.

<Overview of Sport Cheering System>

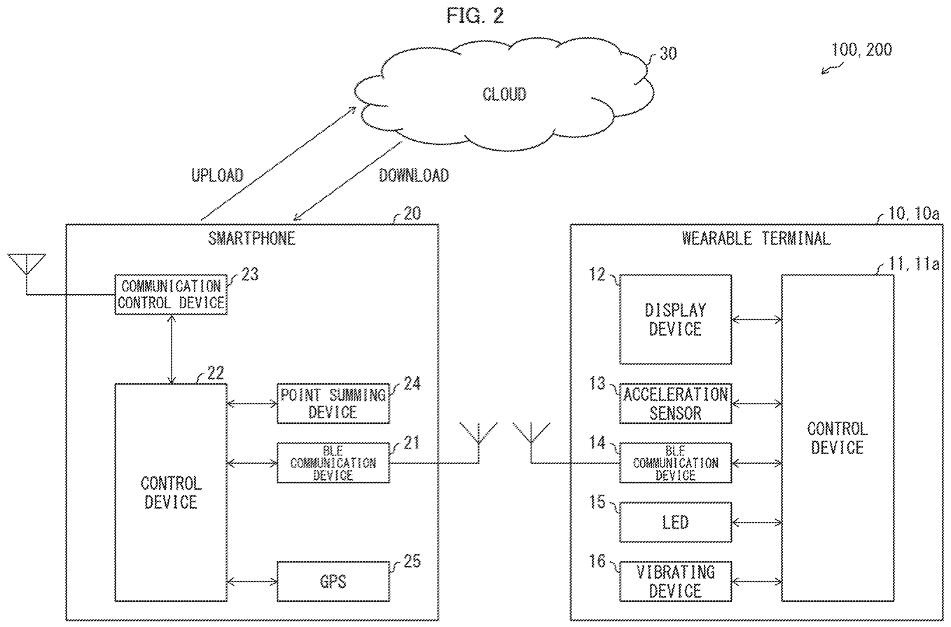

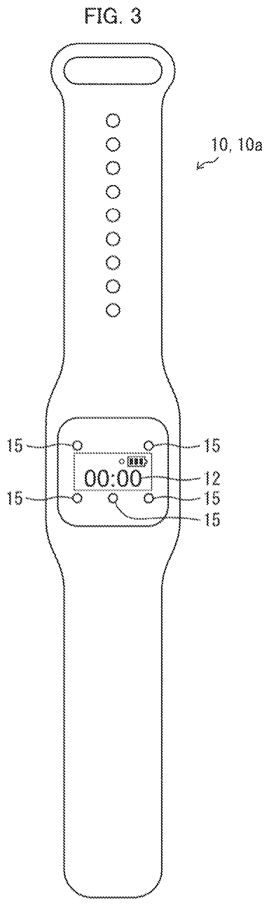

The following first discusses an overview of a sport cheering system 100 in accordance with Embodiment 1, with reference to FIGS. 2 and 3. FIG. 2 is a block diagram schematically illustrating the sport cheering system 100. FIG. 3 illustrates an appearance of a wearable terminal 10.

The sport cheering system 100 is a system that, when a user watches a sport at a stadium or in an area near the stadium, encourages the user to actively perform cheering for the sport. The “area near a stadium” herein assumes a situation where a large-screen monitor is situated in an open space or the like near the stadium and the user watches a sport through the monitor. As illustrated in FIG. 2, the sport cheering system 100 includes the wearable terminal 10, a smartphone 20, and a cloud 30.

The wearable terminal 10 is, as illustrated in FIG. 3, an information terminal that is in the form of a wristwatch and that can be worn on a wrist (body) of the user and carried around. The wearable terminal 10 has various functions to encourage the user to perform cheering for a sport. As illustrated in FIGS. 2 and 3, the wearable terminal 10 includes a control device 11, a display device 12 (information presenting device), an acceleration sensor 13 (motion detecting device), a BLE communication device 14, LEDs 15 (information presenting devices), and a vibrating device 16 (information presenting device).

The control device 11 carries out an overall control of the devices and sections of the wearable terminal 10. The display device 12 is, for example, a liquid crystal display, and displays the user's cheering status in a visible manner such as in the form of a numeric value or text. The display device 12 also displays time and remaining battery level as illustrated in FIG. 3. The acceleration sensor 13 senses a movement of the wearable terminal 10. The BLE communication device 14 (and also a BLE communication device 21, which will be described later) is a device for near field communication between the wearable terminal 10 and the smartphone 20.

The LEDs 15 change their color and intensity of light in response to control by the control device 11, and thereby present the user's cheering status. The number of the LEDs 15 is five, and the LEDs 15 are arranged so as to surround the display device 12 as illustrated in FIG. 3. Specifically, the LEDs 15 are arranged such that: two LEDs 15 are arranged bilateral symmetrically in an area above the display device 12 when seen from a direction perpendicular to the surface of the sheet on which FIG. 3 is printed; two LEDs 15 are arranged bilateral symmetrically in an area below the display device 12 when seen from the direction perpendicular to the surface of the sheet on which FIG. 3 is printed; and one LED 15 is disposed in the middle of the area below the display device 12. The number and arrangement of the LEDs 15 can be changed as appropriate. The vibrating device 16 is, for example, a vibrator, and presents the user's cheering status by means of vibrations of different types and intensities in response to control by the control device 11.

In this arrangement, the display device 12, the LEDs 15, and the vibrating device 16 function as information presenting devices that present information corresponding to a point(s) earned by a user through his cheering motion (hereinafter may be referred to as “motion” for short) (details of the cheering motion and point will be described later). Note that the wearable terminal 10 does not need to include all the following devices: the display device 12, the LEDs 15, and the vibrating device 16. For example, the wearable terminal 10 can include at least one or two of these devices. As another example, the wearable terminal 10 can include a device that carries out an information presenting process (this device is an information presenting device) other than the above three kinds of device.

The smartphone 20 is a multi-function mobile phone that has combined functions of a personal computer, personal digital assistant (PDA), and/or the like. The smartphone 20 includes the BLE communication device 21, a control device 22, a communication control device 23, a point summing device 24, and a GPS 25.

The control device 22 carries out an overall control of various devices and sections of the smartphone 20. The communication control device 23 is a device that serves to exchange data (uploading and downloading) between the smartphone 20 and the cloud 30. The point summing device 24 acquires, via communication between the BLE communication devices 14 and 21, points acquired by the control device 11 of the wearable terminal 10, and sequentially sums the points. The point summing device 24 also uploads the obtained total of the points to the cloud 30, and also transmits the total of the points in response to a call from the control device 11. The GPS 25 accurately determines where a user is present with use of an artificial satellite.

The cloud 30 is a server that stores therein various kinds of data regarding the user's favorite team and/or athlete and that exchanges these various kinds of data between the cloud 30 and the wearable terminal 10 and between the cloud 30 and the smartphone 20. The cloud 30 also stores points transmitted from the wearable terminal 10. The user makes use of the results of various processes carried out by the control device 11 of the wearable terminal 10 and the above various kinds of data stored in the cloud 30 via the smartphone 20, and can thereby enjoy cheering for a sport at a stadium.

Note that, although the wearable terminal 10 is included as a constituent element in the sport cheering system 100 in Embodiment 1 and the subsequent embodiments, this does not imply any limitation. For example, data exchange that is carried out in the sport cheering system 100 can be realized by the wearable terminal 10 alone. The point summing device 24 and the GPS 25 do not need to be included in the smartphone 20, and can alternatively be included in the wearable terminal 10.

<Functional Structure of Control Device>

Next, the following description discusses a functional structure of the control device 11 in accordance with Embodiment 1 with reference to FIG. 1. FIG. 1 is a block diagram illustrating a functional structure of the wearable terminal 10. As illustrated in FIG. 1, the control device 11 includes a motion detecting section 111, a motion determining section 112, a display content deciding section 113, a motion counting/measuring section 114, a point acquiring section 115, a vibration content deciding section 116, an LED control section 117, a location detecting section 118, and a location determining section 119.

The motion detecting section 111 detects a motion of a user based on the result of sensing received from the acceleration sensor 13. The motion determining section 112 determines, based on the result of detection by the motion detecting section 111, whether or not the motion of the user indicated by the result of detection corresponds to at least one cheering motion. The determination is carried out by retrieving a cheering motion data table from a storage device (described later) and checking the result of detection against the table.

In other words, upon sensing of a movement of the wearable terminal 10 by the acceleration sensor 13, at least one cheering motion is detected by the motion detecting section 111 and the motion determining section 112.

As used herein, the term “cheering motion” refers to a motion of the body of a user who is cheering for a sport. For example, two or more cheering motions are pre-set for a user's favorite team. In a case where the user's favorite team is a baseball team, different cheering motions can be pre-set for different innings. In a case where the user has two or more favorite players, different cheering motions can be pre-set for respective different players.

In these cases, the two or more cheering motions are associated with respective innings or players in the cheering motion data table (not illustrated), which is stored in a storage device (not illustrated) contained in the wearable terminal 10, for example. The cheering motion data table can be stored in the cloud 30. Note that it is not essential that two or more cheering motions be pre-set. An arrangement in which only one cheering motion is pre-set can be employed.

The motion counting/measuring section 114 counts and/or measures, in a case where the motion determining section 112 determines that the user's motion corresponds to at least one cheering motion, the number of times the cheering motion is carried out, the frequency at which the cheering motion is carried out, the interval(s) between the cheering motions, and/or the like, based on the result of detection by the motion detecting section 111.

The point acquiring section 115 acquires, based on the result of counting/measurement by the motion counting/measuring section 114, a point(s) corresponding to the cheering motions that were counted/measured by the motion counting/measuring section 114. In other words, in a case where at least one cheering motion is detected through a motion detection process, the point acquiring section 115 carries out a point acquiring process that involves acquiring a point(s) corresponding to the cheering motion.

Every time a point(s) is/are acquired by the point acquiring section 115, the point(s) is/are supplied to the point summing device 24 of the smartphone 20 via the BLE communication device 14 and the BLE communication device 21 of the smartphone 20, and the point summing device 24 finds the total of points. The total of points thus obtained is uploaded to the cloud 30.

Upon receiving, from the point acquiring section 115, information indicating that the point(s) has/have been acquired, the display content deciding section 113 retrieves the current total of points from the point summing device 24, and, in accordance with the current total of points, decides content to be displayed on the display device 12. For example, the following arrangement can be employed: the current total of points is converted into a numeric value (visualized); and the display device 12 is caused to display the numeric value corresponding to the current total of points. The display device 12 can be caused to display, for example, text such as “try harder”, “almost”, or “well done” in accordance with the total of points.

The display content deciding section 113 appropriately changes the content to be displayed on the display device 12 also in accordance with location information received from the location determining section 119 (describe later). For example, assuming that the current total of points is converted into a numeric value, the numeric value resulting from this total of points is greater in the case where the user is present at a stadium than in the case where the user is present in an area near the stadium. Alternatively, for example, assuming that the current total of points is converted into text, the text resulting from this total of points is “well done” in the case where the user is present at the stadium and is “nice try” in the case where the user is present in an area near the stadium.

Upon receiving, from the point acquiring section 115, information indicating that the point(s) has/have been acquired, the vibration content deciding section 116 retrieves the current total of points from the point summing device 24, and, in accordance with the current total of points, decides content of a vibration of the vibrating device 16. For example, the vibration can be repeated at short intervals or long intervals in accordance with the total of points. As another example, the vibration can be made small or large in accordance with the total of points.

The vibration content deciding section 116 appropriately changes the content to be presented by the vibrating device 16 also in accordance with the location information received from the location determining section 119 (described later). For example, even given the same total of points, the vibration of the vibrating device 16 is repeated at shorter intervals or made larger in the case where the user is present at a stadium than in the case where the user is present in an area near the stadium.

Upon receiving, from the point acquiring section 115, information indicating that the point(s) has/have been acquired, the LED control section 117 retrieves the current total of points from the point summing device 24, and, in accordance with the current total of points, controls the manner of light emission by the LEDs 15. For example, light can be made brighter or darker in accordance with the total of points (e.g., light is made brighter when the number of points is larger, light is made darker when the number of points is smaller). As another example, light emission can be carried out in different colors depending on the total of points (e.g., bright orange light is emitted when the number of points is large, blue light is emitted when the number of points is small).

The LED control section 117 appropriately changes the manner of light emission by the LEDs 15 also in accordance with the location information received from the location determining section 119 (described later). For example, even given the same total of points, the LEDs 15 are caused to emit brighter light in the case where the user is present at a stadium than in the case where the user is present in an area near the stadium. As another example, even given the same total of points, the LEDs 15 is caused to emit more yellowish or reddish light in the case where the user is present at a stadium than in the case where the user is present in an area near the stadium.

The location detecting section 118 detects the current location of the user based on information received from the GPS 25 of the smartphone 20. The location determining section 119 determines, based on the current location of the user received from the location detecting section 118, in which area the user is currently present.

Specifically, the location determining section 119 determines in which area the user is currently present by, for example, retrieving a location data table (not illustrated) from a storage device contained in the wearable terminal 10 and checking the address of the current location against the location data table. The location data table is a data table which associates specific areas that are included in the user's action pattern (e.g., stadium, area near the stadium, office, and/or the like) with addresses of these areas. The location data table can be stored in the cloud 30.

Through use of the location determining section 119, the control device 11 acquires location information related to a place in which the user is cheering for a sport, that is, acquires location information related to a stadium or an area near the stadium. In other words, a location information acquiring process is carried out by the location determining section 119. The “location information” here refers to a result of determination of whether or not the user is present at a stadium or a result of determination of whether or not the user is present in an area near the stadium. The location information is transmitted to the display content deciding section 113, the vibration content deciding section 116, and to the LED control section 117.

Note that the control device 11 does not necessarily need to include the foregoing display content deciding section 113, vibration content deciding section 116, LED control section 117, location detecting section 118, and location determining section 119. For example, the control device 11 can include at least one of or two of the following sections: the display content deciding section 113, the vibration content deciding section 116, and the LED control section 117, in accordance with the type(s) of information presenting device(s) included in the wearable terminal 10. As another example, the point acquiring section 115 can decide how many points to acquire independently of the current location of the user. In this case, the control device 11 does not need to include the location detecting section 118 and the location determining section 119.

<Method of Controlling Wearable Terminal>

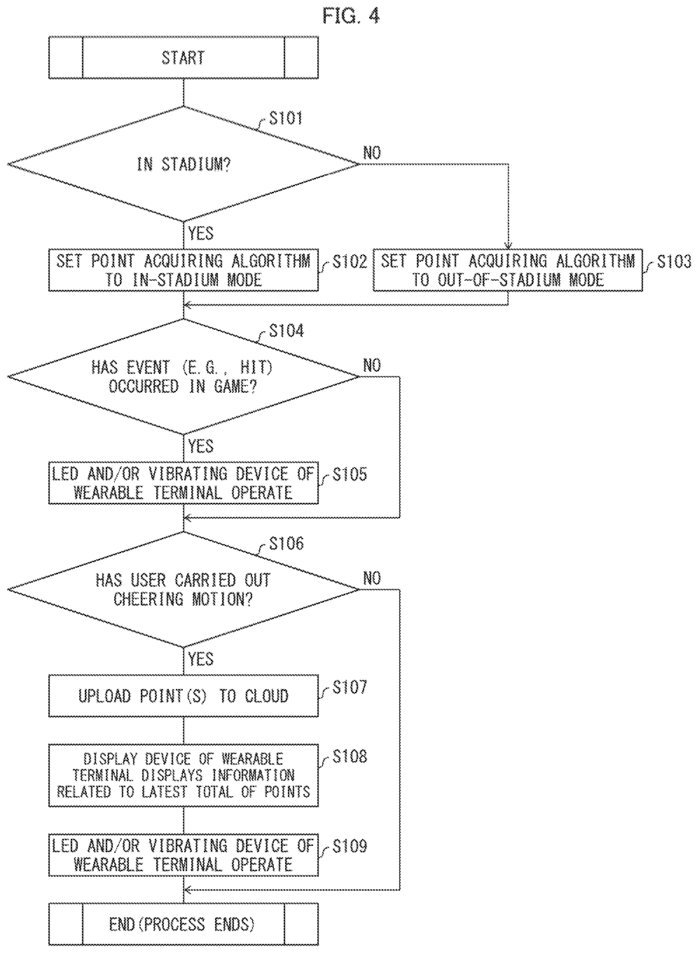

Next, the following describes a method of controlling the wearable terminal 10 with reference to FIG. 4. FIG. 4 is a flowchart showing an example of the method of controlling the wearable terminal 10. As shown in FIG. 4, first, in step S101, the location determining section 119 determines, based on the current location of a user received from the location detecting section 118, whether the user is present at a stadium or in an area near the stadium, and the process proceeds to step S102 (“step Snnn” is hereinafter referred to as “Snnn” for short). In other words, the control device 11 acquires location information indicating that the user is present at a stadium or location information indicating that the user is present in an area near the stadium.

Next, if it is determined that the user is present at the stadium in S101 (YES in S101), that is, if the control device 11 acquires the location information indicating that the user is currently present at the stadium, the point acquiring section 115 sets a point acquiring algorithm to an “in-stadium mode”, and the process proceeds to S104. On the contrary, if it is determined that the user is not present at the stadium in S101 (NO in S101), the point acquiring section 115 sets the point acquiring algorithm to an “out-of-stadium mode” and the process proceeds to S104. In a case where the point acquiring algorithm is set to the in-stadium mode, more points can be earned than when the algorithm is set to the out-of-stadium mode, even when the same cheering motion is measured/counted by the motion counting/measuring section 114.

Next, in S104, the vibration content deciding section 116 and the LED control section 117 are in a state waiting for receipt, from the smartphone 20 or the cloud 30, of information indicating that an event has occurred in a game (for example, in a case where the user is watching a baseball game, there was a hit in user's favorite team's offensive inning). Note that the occurrence of the event can be sensed by the wearable terminal 10.

If it is determined that an event has occurred (if the information is received) (YES in S104), the LEDs 15 emit light and the vibrating device 16 vibrates, and the process proceeds to S106. Note that, in this case, for example, the display content deciding section 113 can cause the display device 12 to display “hit” or the like. On the contrary, if it is determined that no even has occurred (NO in step S104), neither the LEDs 15 nor the vibrating device 16 operates, and the process proceeds to S106.

Next, in S106, the motion determining section 112 determines, based on the result of sensing by the acceleration sensor 13 and the result of detection by the motion detecting section 111, whether or not the user has made a cheering motion (motion detecting step). If it is determined that the user has made a cheering motion (YES in S106), the cheering motion and a point(s) corresponding to the pre-set point acquiring algorithm are uploaded to the cloud 30 (S107: point acquiring step). Furthermore, the motion counting/measuring section 114 count/measures, if it is determined that the user has made a cheering motion (YES in S106), the number of times the cheering motion is carried out, frequency at which the cheering motion is carried out, and/or the like based on the result of detection by the motion detecting section 111, and causes the storage device of the wearable terminal 10 to store them. On the contrary, if it is determined that the user has made no cheering motion (NO in S106), a series of processes ends.

Next, the current total of points stored in the point summing device 24 is retrieved and thereby information related to the total of points is presented to the user, and a series of processes ends. Specifically, some information related to the total of points is displayed on the display device 12 (S108), and the LEDs 15 emit light and the vibrating device 16 vibrates (S109).

Note that the above examples of the manner of information presentation do not imply any limitation, and the display device 12, the LEDs 15, and the vibrating device 16 included in the wearable terminal 10 can be used to present information to the user in various manners. For example, the following arrangement can be employed: the display content deciding section 113 is capable of acquiring, from another wearable terminal (another electronic apparatus) other than the wearable terminal 10, point information stored in a control device of the another wearable terminal (i.e., the display content deciding section 113 is capable of carrying out a point information acquiring process). As used herein, the term “point information” refers to information related a point(s) acquired by a point acquiring section of the another wearable terminal.

In this case, the point(s) related to the point information acquired by the display content deciding section 113 is/are also converted into a numeric value (visualized) and then displayed on the display device 12. Achieving such a process makes it possible for one user to easily know the cheering status of another user, and thus makes it possible for the users to cheer with a feeling of unity.

Note that, although Embodiment 1 and the subsequent embodiments are described based on an example in which a cheering motion (i.e., a gesture that shows a favorable attitude toward a specific target) is employed, Embodiment 1 and the subsequent embodiments are not limited as such. For example, Embodiment 1 and the subsequent embodiments can employ a motion that shows an unfavorable attitude toward a team other than the favorite team or can employ a motion that shows an unfavorable attitude even toward the favorite team. Furthermore, Embodiment 1 and the subsequent embodiments can employ a general motion of the user's body, instead of a motion of the user's body during the user's watching a sport.

### Embodiment 2

The following description will discuss another embodiment of the present invention with reference to FIGS. 1 to 3 and 5. For convenience of description, members having functions identical to those described in Embodiment 1 are assigned identical referential numerals and their descriptions are omitted.

<Overview of Sport Cheering System and Wearable Terminal>

First, the following discusses an overview of a sport cheering system 200 in accordance with Embodiment 2 of the present invention and a wearable terminal 10a in accordance with Embodiment 2 of the present invention, with reference to FIGS. 1 to 3. FIG. 1 is a block diagram illustrating a functional structure of the wearable terminal 10a. FIG. 2 is a block diagram schematically illustrating the sport cheering system 200. FIG. 3 illustrates an appearance of the wearable terminal 10a.

A point acquiring section 115 in accordance with Embodiment 2 is different from the point acquiring section 115 in accordance with Embodiment 1 in that the point acquiring section 115 in accordance with Embodiment 2 acquires more points when at least one specific cheering motion (specific motion) is detected than when a cheering motion other than specific cheering motions is detected. The term “specific cheering motion” refers to a typical cheering gesture that is pre-set for a specific target to be cheered for, such as a user's favorite team or athlete.

A display content deciding section 113, the point acquiring section 115, and a vibration content deciding section 116 in accordance with Embodiment 2 are different from the display content deciding section 113, the point acquiring section 115, and the vibration content deciding section 116 in accordance with Embodiment 1 in that, in Embodiment 2, information related to a point(s) corresponding to a specific cheering motion (described later) is presented every time the specific cheering motion is detected.

The specific cheering motion, that is, a cheering gesture, is different between when the user cheers at the stadium and when the user cheers in an area near the stadium, even if the specific cheering motion is targeted at the same team or athlete. The phrase “cheering gesture is different” means either that the cheering gesture itself is different or that the cheering gesture itself is the same but the range of movement of the body is different.

Specifically, in a case where a specific cheering motion is detected by the acceleration sensor 13, the motion detecting section 111, and the motion determining section 112, the point acquiring section 115 retrieves a specific cheering motion data table (not illustrated) from a storage device (not illustrated) of the wearable terminal 10a. The “specific cheering motion data table” refers to a data table which associates the user's favorite teams and/or athletes with respective specific cheering motions.

The point acquiring section 115 checks which of the specific cheering motions stored in the specific cheering motion data table matches the detected specific cheering motion, and acquires points that correspond to the matched specific cheering motion. The number of points acquired here is more than that acquired when the user cheers for the same team/athlete with use of a cheering motion other than the specific cheering motion.

Embodiment 2 deals with an arrangement in which the number of points to be acquired is decided based on whether or not the detected specific cheering motion matches any of the specific cheering motions stored in the specific cheering motion data table; however, Embodiment 2 is not limited to such an arrangement. For example, the following arrangement can be employed: the number of points to be acquired varies depending on to what degree the detected specific cheering motion matches a specific cheering motion(s) stored in the specific cheering motion data table.

Specifically, the following arrangement can be employed: the detected specific cheering motion is compared with a reference cheering motion (reference motion) which is a standard gesture of cheering for a specific target to be cheered for (specific target); and the number of points to be acquired is increased or decreased in accordance with the result of the comparison. The reference cheering motion here can be, for example, a plurality of specific cheering motions stored in the foregoing specific cheering motion data table. The result of the comparison indicates to what degree the detected specific cheering motion matches the reference cheering motion.

Achieving such a process achieves an arrangement in which more points are earned when the detected specific cheering motion is closer to the reference cheering motion, and thus makes it possible to further enhance the user's motivation for cheering.

For example, the following process can be employed: the point acquiring section 115 retrieves the current total of points from the point summing device 24 of the smartphone 20; and information related to the current total of points is used as virtual currency (an indicator indicative of a positive evaluation of a specific target to be cheered for) (that is, a point indicator process can be carried out).

As used herein, the term “virtual currency” refers to a type of virtual money that is usable in a cheering application installed on the wearable terminal 10. The term “current total of points” refers to the current sum total of accumulated points that have been obtained by sequentially adding, by the point summing device 24, a point(s) each time a specific cheering motion is detected.

Achieving such a process makes it possible for a user to vote for the user's favorite athlete/team through the use of virtual currency. This in combination with cheering using a specific cheering motion makes it possible to further enhance the user's motivation for cheering.

A control device 11a, the wearable terminal 10a, and the sport cheering system 200 in accordance with Embodiment 2, except for the display content deciding section 113, the point acquiring section 115, the vibration content deciding section 116, and the LED control section 117, are the same in configuration as the control device 11, the wearable terminal 10, and the sport cheering system 100 in accordance with Embodiment 1, as illustrated in FIGS. 1 to 3.

<Method of Controlling Wearable Terminal>

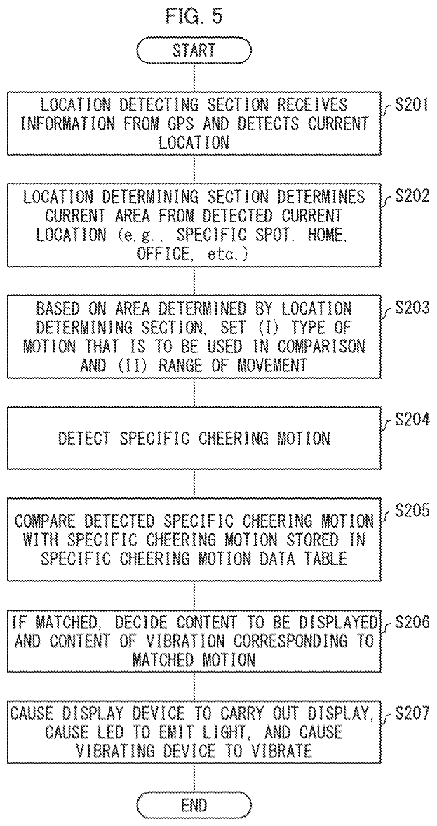

Next, the following discusses a method of controlling the wearable terminal 10a with reference to FIG. 5. FIG. 5 is a flowchart showing an example of a method of controlling the wearable terminal 10a. As shown in FIG. 5, first, in S201, the location detecting section 118 receives information from the GPS 25 of the smartphone 20 and detects the current location of a user. Then, the process proceeds to S202. In S202, the location determining section 119 determines, based on the current location thus detected, in which area the user is currently present. Then, the process proceeds to S203.

Next, in S203, if the control device 11a acquires location information based on the result of determination by the location determining section 119, the point acquiring section 115 retrieves a specific cheering motion data table. Then, the point acquiring section 115 sets, based on the location information, (i) a type of motion that is to be used in a comparison (any of a plurality of specific cheering motions stored in the specific cheering motion data table) and (ii) a range of movement of the body when the user moves his body for that motion. Then, the process proceeds to S204. In S204, a specific cheering motion is detected by the acceleration sensor 13, the motion detecting section 111, and the motion determining section 112 (motion detecting step). Then, the process proceeds to S205.

Next, the point acquiring section 115 compares the detected specific cheering motion with the specific cheering motion (which was set in the process of S203) stored in the specific cheering motion data table (S205).

If the detected specific cheering motion matches the specific cheering motion stored in the specific cheering motion data table, the point acquiring section 115 acquires a point(s) corresponding to the matched specific cheering motion. Then, the display content deciding section 113, the vibration content deciding section 116, and the LED control section 117 decide the content to be displayed on the display device 12, the manner in which the vibrating device 16 vibrates, and the manner in which the LEDs 15 emit light, in accordance with the point(s) corresponding to the matched specific cheering motion (S206: point acquiring step). Then, the process proceeds to S207.

In S207, based on the content and manners decided in the process of S206, the display content deciding section 113 causes the display device 12 to display a numeric value corresponding to the point(s), the LED control section 117 causes the LEDs 15 to emit light of a predetermined color and brightness, and the vibration content deciding section 116 causes the vibrating device 16 to vibrate at a predetermined frequency and magnitude. Then, a series of processes ends.

[Software Implementation Example]

Control blocks of the control device (11, 11a) (particularly, the motion detecting section 111 and the point acquiring section 115) can be realized by a logic circuit (hardware) provided in an integrated circuit (IC chip) or the like or can be alternatively realized by software.

In the latter case, the control device (11, 11a) includes a computer that executes instructions of a program that is software realizing the foregoing functions. The computer, for example, includes one or more processors (control devices) and a computer-readable storage medium storing the program. An object of the present invention can be achieved by the processor of the computer reading and executing the program stored in the storage medium. Examples of the processor encompass a central processing unit (CPU). Examples of the storage medium encompass a “non-transitory tangible medium” such as a read only memory (ROM), a tape, a disk, a card, a semiconductor memory, and a programmable logic circuit. The computer may further include a random access memory (RAM) or the like in which the program is loaded. Further, the program may be made available to the computer via any transmission medium (such as a communication network and a broadcast wave) which allows the program to be transmitted. Note that an aspect of the present invention can also be achieved in the form of a computer data signal in which the program is embodied via electronic transmission and which is embedded in a carrier wave.

Aspects of the present invention can also be expressed as follows:

An electronic apparatus (wearable terminal 10, 10a) in accordance with Aspect 1 of the present invention is an electronic apparatus including: at least one motion detecting device (acceleration sensor 13); and at least one control device (11, 11a), the at least one control device being configured to, in a case where at least one motion is detected by the at least one motion detecting device, carry out a point acquiring process that includes acquiring a point(s) corresponding to the at least one motion, the at least one motion each being a motion of a body of a user.

According to the above arrangement, upon detection of a motion by the motion detecting device, the control device acquires a point(s) corresponding to that motion. Accordingly, for example, when the control device causes a display device of the electronic apparatus to display accumulated points (which are obtained by accumulating the acquired points) in the form of a numeric value or the like, a user who sees the result of his cheering displayed in the form of a numeric value or the like will have enhanced motivation for cheering. The motivation is enhanced also by, through control by the control device, employing an arrangement in which the brightness of light emitted by LEDs of the electronic apparatus increases every time a point(s) is/are acquired and/or a vibrating device of the electronic apparatus vibrates more actively.

The motivation is enhanced also by the following arrangement: more points are acquired when a motion corresponding to a specific target such as a user's favorite team is detected by the motion detecting section than when some other motion is detected. The motivation is further enhanced by employing the following arrangement: more points are acquired when the motion corresponding to the specific target is closer to, for example, a typical cheering gesture for the user's favorite team.

Furthermore, for example, with an arrangement in which points earned by another user are also displayed in the form of a numeric value or the like and in which more points are acquired when the user cheers at the stadium than when the user cheers outside the stadium, it is possible to make the user want to go to the stadium and cheer with the another user.

In Aspect 2 of the present invention, the electronic apparatus (wearable terminal 10) of Aspect 1 can be arranged such that the electronic apparatus further includes at least one information presenting device and that the at least one control device is configured to further carry out an information presenting process that includes causing the at least one information presenting device to present information corresponding to accumulated points, the accumulated points having been obtained by sequentially adding the point(s) acquired through the point acquiring process each time the at least one motion is detected.

According to the above arrangement, the control device causes the information presenting device to present information corresponding to the accumulated points. As such, for example, it is possible to achieve an arrangement in which the brightness of light emitted by an LED (information presenting device) of the electronic apparatus increases every time a point(s) is/are acquired and/or a vibrating device (information presenting device) of the electronic apparatus vibrates more actively. This makes it possible to further enhance the user's motivation for cheering.

In Aspect 3 of the present invention, the electronic apparatus of Aspect 2 can be arranged such that the information presenting process includes causing the at least one information presenting device to display the accumulated points in a visible manner.

According to the above arrangement, the control device causes the information presenting device to display the accumulated points in a visible manner. As such, for example, when the information presenting device of the electronic apparatus is caused to display the accumulated points in the form of a numeric value, the user who sees the result of his cheering displayed in the form of a numeric value will have further enhanced motivation for cheering.

In Aspect 4 of the present invention, the electronic apparatus of Aspect 3 can be arranged such that: the at least one control device is configured to further carry out a point information acquiring process, the point information acquiring process including acquiring point information related to points accumulated in a control device of another electronic apparatus; and the information presenting process includes causing the at least one information presenting device to also display, in a visible manner, the points related to the point information acquired through the point information acquiring process.

According to the above arrangement, the control device causes the information presenting device to also display, in a visible manner, points accumulated in a control device of another electronic apparatus, in addition to the accumulated points stored in itself. This makes it possible for the user to easily know the cheering status of another user, and thus possible for the users to cheer with a feeling of unity. This makes it possible to further enhance the user's motivation for cheering and also possible to make the user more strongly think that he wants to cheer at the stadium.

In Aspect 5 of the present invention, the electronic apparatus (wearable terminal 10a) of any one of Aspects 1 to 4 can be arranged such that the at least one control device (11a) is configured to carry out the point acquiring process so as to acquire more points in a case where at least one specific motion corresponding to a specific target is detected by the at least one motion detecting device than in a case where a motion other than the specific motion is detected by the at least one motion detecting device.

According to the above arrangement, the control device acquires more points when a specific motion corresponding to a specific target is detected by the motion detecting device than when a motion other than the specific motion is detected. As such, in a case where, for example, the user cheers for his favorite team, the user earns more points than when he cheers for some other team. This makes it possible to further enhance the user's motivation for cheering.

In Aspect 6 of the present invention, the electronic apparatus of Aspect 5 can be arranged such that the point acquiring process includes, in the case where the at least one specific motion is detected by the at least one motion detecting device, (i) comparing the at least one specific motion thus detected with a reference motion that is a standard gesture for the specific target and (ii) in accordance with a result of comparison, increasing or reducing the number of points to be acquired.

According to the above arrangement, the control device compares the detected specific motion with a reference motion and, in accordance with the result of the comparison, increases or decreases the number of points to be acquired. This makes it possible to achieve an arrangement in which more points are acquired when the specific motion detected by the motion detecting device is closer to, for example, a typical cheering gesture for the user's favorite team, and thus possible to further enhance the user's motivation for cheering.

In Aspect 7 of the present invention, the electronic apparatus of Aspect 5 or 6 can be arranged such that the at least one control device is configured to further carry out a point indicator process that includes using accumulated points as an indicator indicative of a positive evaluation of the specific target, the accumulated points having been obtained by sequentially adding the point(s) acquired through the point acquiring process each time the at least one specific motion is detected.

According to the above arrangement, the control device uses accumulated points (which have been obtained by sequentially adding the point(s) each time the motion detecting device detects the specific motion) as an indicator that is indicative of a positive evaluation of a specific target. Therefore, by employing an arrangement in which the accumulated points are used as, for example, virtual currency in a cheering application installed on the electronic apparatus and in which the user can vote for his favorite athlete/team through the use of the virtual currency, it is possible to further enhance the user's motivation for cheering.

In Aspect 8 of the present invention, the electronic apparatus (wearable terminal 10, 10a) of any one of Aspects 1 to 7 can be arranged such that: the at least one control device (11, 11a) is configured to further carry out a location information acquiring process that includes acquiring location information related to a location where the user is present; and the point acquiring process includes acquiring the point(s) which correspond(s) to (i) the location information acquired through the location information acquiring process and (ii) the at least one motion.

According to the above arrangement, the control device carries out a point acquiring process and thereby acquires a point(s) corresponding to the location information and motion. This makes it possible to achieve an arrangement in which, for example, more points are acquired when the user cheers at the stadium than when the user cheers outside the stadium, and thus makes it possible to make the user more strongly think that he wants to cheer at the stadium.

A control device (11, 11a) in accordance with Aspect 9 of the present invention is a control device for controlling an electronic apparatus (wearable terminal 10, 10a), the control device including a point acquiring section (115) that is configured to, in a case where at least one motion is detected by a motion detecting device (acceleration sensor 13), acquire a point(s) corresponding to the at least one motion, the at least one motion each being a motion of a body of a user.

The above arrangement makes it possible to provide a control device that causes an electronic apparatus to make a response in a way that enhances the motivation for cheering for a sport and that makes the user want to cheer at the stadium.

A control method in accordance with Aspect 10 of the present invention is a method of controlling an electronic apparatus, the method including: a motion detecting step (S106, S204) including detecting at least one motion, the at least one motion each being a motion of a body of a user; and a point acquiring step (S107, S206) including, in a case where the at least one motion is detected in the motion detecting step, acquiring a point(s) corresponding to the at least one motion.

The above arrangement makes it possible to provide a control method that causes an electronic apparatus to make a response in a way that enhances the motivation for cheering for a sport and that makes the user want to cheer at the stadium.

A control device in accordance with each aspect of the present invention can be realized by a computer. The computer is operated based on (i) a program for causing the computer to realize the control device by causing the computer to operate as each section (software element) included in the control device and (ii) a computer-readable storage medium in which the program is stored. Such a program and a computer-readable storage medium are included in the scope of the present invention.

[Remarks]

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

10 wearable terminal (electronic apparatus)
11 control device
12 display device (information presenting device)
13 acceleration sensor (motion detecting device)
15 LED (information presenting device)
16 vibrating device (information presenting device)
115 point acquiring section

1. An electronic apparatus comprising:
at least one motion detecting device; and
at least one control device,
the at least one control device being configured to, in a case where at least one motion is detected by the at least one motion detecting device, carry out a point acquiring process that includes acquiring a point(s) corresponding to the at least one motion, the at least one motion each being a motion of a body of a user.

2. The electronic apparatus according to claim 1, further comprising at least one information presenting device,
wherein the at least one control device is configured to further carry out an information presenting process that includes causing the at least one information presenting device to present information corresponding to accumulated points, the accumulated points having been obtained by sequentially adding the point(s) acquired through the point acquiring process each time the at least one motion is detected.

3. The electronic apparatus according to claim 2, wherein the information presenting process includes causing the at least one information presenting device to display the accumulated points in a visible manner.

4. The electronic apparatus according to claim 3, wherein:
the at least one control device is configured to further carry out a point information acquiring process, the point information acquiring process including acquiring point information related to points accumulated in a control device of another electronic apparatus; and
the information presenting process includes causing the at least one information presenting device to also display, in a visible manner, the points related to the point information acquired through the point information acquiring process.

5. The electronic apparatus according to claim 1, wherein the at least one control device is configured to carry out the point acquiring process so as to acquire more points in a case where at least one specific motion corresponding to a specific target is detected by the at least one motion detecting device than in a case where a motion other than the specific motion is detected by the at least one motion detecting device.

6. The electronic apparatus according to claim 5, wherein the point acquiring process includes, in the case where the at least one specific motion is detected by the at least one motion detecting device, (i) comparing the at least one specific motion thus detected with a reference motion that is a standard gesture for the specific target and (ii) in accordance with a result of comparison, increasing or reducing the number of points to be acquired.

7. The electronic apparatus according to claim 5, wherein the at least one control device is configured to further carry out a point indicator process that includes using accumulated points as an indicator indicative of a positive evaluation of the specific target, the accumulated points having been obtained by sequentially adding the point(s) acquired through the point acquiring process each time the at least one specific motion is detected.

8. The electronic apparatus according to claim 1, wherein:
the at least one control device is configured to further carry out a location information acquiring process that includes acquiring location information related to a location where the user is present; and
the point acquiring process includes acquiring the point(s) which correspond(s) to (i) the location information acquired through the location information acquiring process and (ii) the at least one motion.

9. A non-transitory computer-readable storage medium storing therein a program for causing a computer to function as the at least one control device of an electronic apparatus according to claim 1.

10. A control device for controlling an electronic apparatus,
the control device comprising a point acquiring section that is configured to, in a case where at least one motion is detected by a motion detecting device, acquire a point(s) corresponding to the at least one motion, the at least one motion each being a motion of a body of a user.

11. A method of controlling an electronic apparatus, the method comprising:
a motion detecting step comprising detecting at least one motion, the at least one motion each being a motion of a body of a user; and
a point acquiring step comprising, in a case where the at least one motion is detected in the motion detecting step, acquiring a point(s) corresponding to the at least one motion.
